(19) United States
(12) Patent Application Publication
(10) Pub. No.: US 2004/0140986 A1
(43) Pub. Date: Jul. 22, 2004

(54) Systems and methods for facilitating printing through interface exportation

(76) Inventor: John Leland Boldon, Emmett, ID (US)

Correspondence Address: HEWLETT-PACKARD COMPANY, Intellectual Property Administration, P.O. Box 272400, Fort Collins, CO, 80527-2400, US

(21) Appl. No.: 10/345,868

(22) Filed: Jan. 16, 2003

(51) Int. Cl. G09G 5/00

(52) U.S. Cl. 345/700; 345/866

(57) ABSTRACT

Disclosed are systems and methods for facilitating printing through interface exportation. In one embodiment, a system and method pertain to importing an interface received from a computing device, facilitating display of the interface, receiving selections entered by a user using the imported interface, and facilitating printing in accordance with the printing selections.

### BACKGROUND

With the advent of handheld computing devices such as personal digital assistants (PDAs), persons often now carry data along with them as they travel from place to place. Data stored on these devices may be printed by, for example, synchronizing the handheld device with the user's computer (e.g., personal computer (PC)), downloading the data to an appropriate program that executes on the computer, and then transmitting the data from the computer to an imaging device such as a printer.

When such an individual wishes to print a hardcopy, but is away from his or her computer, that individual may need to find a local imaging device to which the data stored on the handheld device may be directly transmitted, for instance using wireless communications. Unfortunately, there typically are hurdles to printing in such situations. In some cases, printing is not possible unless the source device (i.e., handheld device) comprises a driver that acts as a translator between the source application executing on the source device and the end device (i.e., imaging device). Although such a driver could be installed on the user's handheld device, the user typically must first locate an individual (e.g., information technology (IT) professional) that possesses the driver software or firmware. Where the user is at a foreign location, for instance a client's office, this may be difficult to achieve on short order. Moreover, even if this software/firmware can be located, the user may not wish to install it given that the storage capacity of the handheld device may be limited and the user may not ever need to print to that particular imaging device again.

Printing is sometimes feasible even if the user does not have the specific driver used with the target imaging device. For example, the handheld device may be configured to transmit data in a format that the imaging device is configured to recognize (e.g., American Standard Code for Information Interchange (ASCII) text). In such a case, printing may be possible, but the user typically will have little control over the printing outcome. In particular, the user may not be able to make selections that pertain to the specific capabilities of the imaging device such as font selection, simplex or duplex printing, and various finishing options. Accordingly, although a raw printout may be obtained, the user may not be able to utilize the full functionality of the imaging device.

In some situations, the capabilities of the imaging device may be accessed directly through an imaging device interface. For example, several higher-end imaging devices now include control panel displays that permit the user to enter commands directly into the imaging device. If such an imaging device is the target device, it may be possible for the user to make such selections via the device control panel. Even where this is possible, however, the user would need to enter commands and receive feedback from two different displays, one on the handheld device and one on the imaging device, all while making sure the communication link between the handheld device and the imaging device is not broken, which may be particularly difficult where line-of-sight communications (e.g., infrared (IR)) are used.

### SUMMARY

Disclosed are systems and methods for facilitating printing through interface exportation. In one embodiment, a system and method pertain to importing an interface received from a computing device, facilitating display of the interface, receiving selections entered by a user using the imported interface, and facilitating printing in accordance with the printing selections.

In another embodiment, a system and method pertain to exporting an interface to an imaging device, receiving selection of a document to be printed from the imaging device that has entered by a user using the exported interface, and facilitating transmission of the selected document to the imaging device to facilitate printing of the document.

### BRIEF DESCRIPTION OF THE DRAWINGS

The disclosed systems and methods can be better understood with reference to the following drawings. The components in the drawings are not necessarily to scale.

FIG. 1 is a schematic view of an embodiment of a system through which printing facilitated by interface exportation may be obtained.

FIG. 2 is a block diagram of an embodiment of a handheld computing device shown in FIG. 1.

FIG. 3 is a block diagram of an embodiment of an imaging device shown in FIG. 1.

FIG. 4 is a flow diagram that illustrates an embodiment of operation of the system shown in FIG. 1 in providing printing facilitated by interface exportation.

FIGS. 5A and 5B provide a flow diagram that illustrates an embodiment of operation of an interface exportation manager of the handheld computing device shown in FIG. 2.

FIGS. 6A and 6B provide a flow diagram that illustrates an embodiment of operation of an interface importation manager of the imaging device shown in FIG. 3.

FIG. 7 is a schematic view of a control panel display of an imaging device displaying an interface exported from a handheld computing device.

### DETAILED DESCRIPTION

As identified above, printing from a handheld computing device to a local imaging device can be problematic, particularly where the user wishes to access the full capabilities of the imaging device. As is described below, however, full utilization of a target imaging device can be obtained by exporting an interface from the user's handheld computing device to the imaging device. In such a case, the handheld computing device can harness the display of the imaging device so that printing of a data stored on the computing device can be controlled through the imaging device display. With such operation, the user can control printing without having to split his or her attention between two separate device interfaces.

In the following discussion, specific systems and methods, are described. These systems and methods are mere embodiments, however, that are provided for purposes of example in explaining the manner in which printing may be facilitated through interface exportation. Accordingly, many alternatives are feasible. For instance, although “printing” is specifically discussed, other imaging device functionalities can be accessed through interface exportation including, for example, faxing and digital sending.

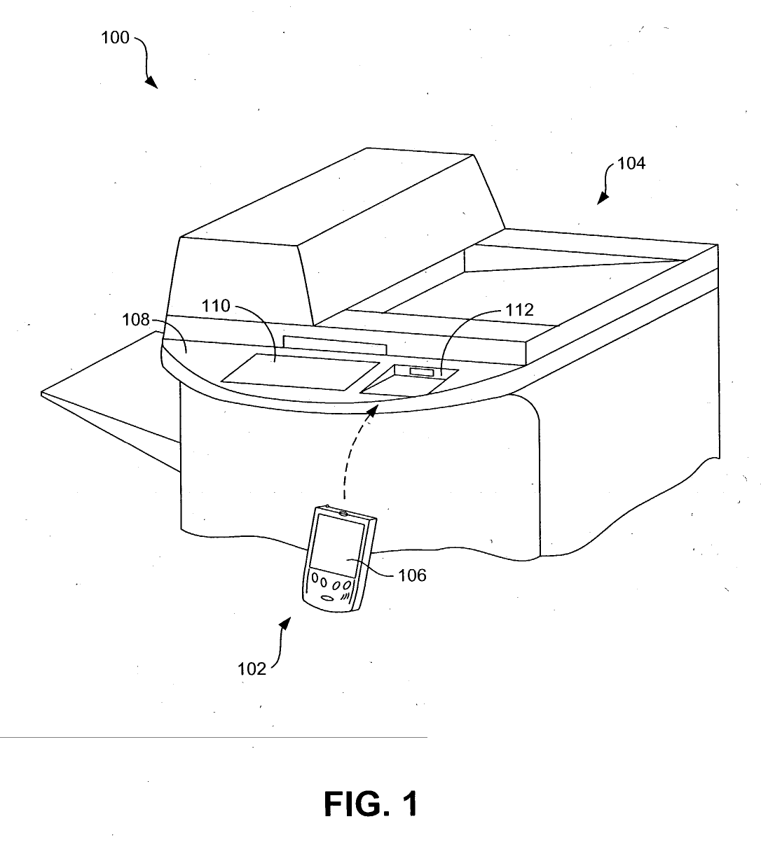

Referring now in more detail to the figures in which like numerals identify corresponding parts, FIG. 1 illustrates an example system 100 in which printing can be facilitated through interface exportation. As indicated in this figure, the system 100 generally comprises a handheld computing device 102 and an imaging device 104. As indicated in FIG. 1, the handheld computing device 102 can, for instance, comprise a personal digital assistant (PDA). Although a PDA is illustrated in the figure and specifically identified herein, other handheld computing devices could be used in the system 100. For example, the computing device could comprise a mobile telephone, a pager, a tablet computer, or the like. Moreover, although “handheld” computing devices are specifically discussed herein, the present disclosure is equally applicable to other portable computing devices including notebook computers.

As indicated in FIG. 1, the handheld computing device 102 typically comprises a display 106 with which information may be communicated to the user and, optionally, with which the user may enter commands with the device (e.g., in the case where the display is a touch-sensitive screen).

As illustrated in FIG. 1, the imaging device 104 may comprise a printer. More generally, however, the imaging device 104 comprises substantially any device that is capable of receiving data and generating a hardcopy output pertaining to the received data. Accordingly, the imaging device could alternatively comprise a photocopier, a multifunction peripheral (MFP) device, an all-in-one device, a facsimile device, etc. The imaging device 104 includes a control panel 108 that comprises a display 110. To facilitate communication between the handheld computing device 102 and the imaging device 104, the control panel 108 may further include a docking station 112 that provides a means for docking the handheld computing device on the imaging device such that communication components (e.g., wireless transceivers) of the two devices are maintained in alignment.

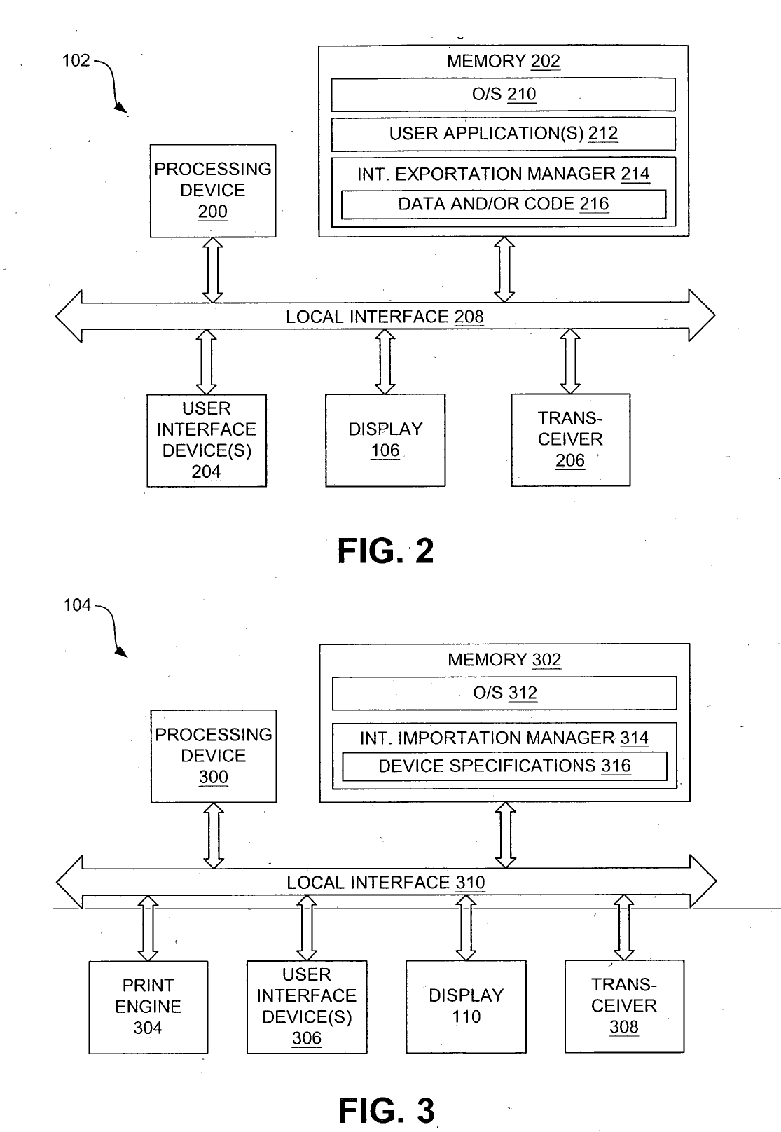

FIG. 2 is a block diagram illustrating an example architecture for the handheld computing device 102 shown in FIG. 1. As indicated in FIG. 2, the handheld computing device 102 comprises a processing device 200, memory 202, user interface devices 204, the display 106 (FIG. 1), and a transceiver 206, each of which is connected to a local interface 208. The processing device 200 can include any custom made or commercially available processor, a central processing unit (CPU) or an auxiliary processor among several processors associated with the handheld computing device 102, a semiconductor based microprocessor (in the form of a microchip), or a macroprocessor. The memory 202 can include any one or a combination of volatile memory elements (e.g., random access memory (RAM, such as DRAM, SRAM, etc.)) and nonvolatile memory elements (e.g., Flash, MRAM, ARS memory, etc.).

The user interface devices 204 comprise those components with which the user controls the handheld computing device 102. As depicted in FIG. 1, these interface devices 204 can include one or more buttons provided on the computing device 102. The display 106 (FIG. 1) typically comprises a liquid crystal display (LCD) and is used to present a graphical user interface (GUI) to the user. In cases in which the display 106 is touch-sensitive, the display may be considered to be a user interface device 204 in that commands may be entered by touching discrete portions of the display.

The transceiver 206 is used to enable communications back and forth between the handheld computing device 102 and the imaging device 104. The transceiver 206 is normally configured for wireless transmission (e.g., infrared (IR) or radio frequency (RF)) to avoid difficulties with physical incompatibilities between the handheld computing device 102 and the imaging device 104 that may arise due to distinct electrical connectors that may be provided on the devices.

The memory 202 normally comprises various programs (in software and/or firmware) including an operating system (O/S) 212, one or more user applications 212, and an interface exportation manager 214. The O/S 212 controls the execution of other programs and provides scheduling, input-output control, file and data management, memory management, and communication control and related services. The user applications 212 comprise programs that may serve as source applications for print jobs. By way of example, these applications 212 comprise a word processing application, an email application, or the like.

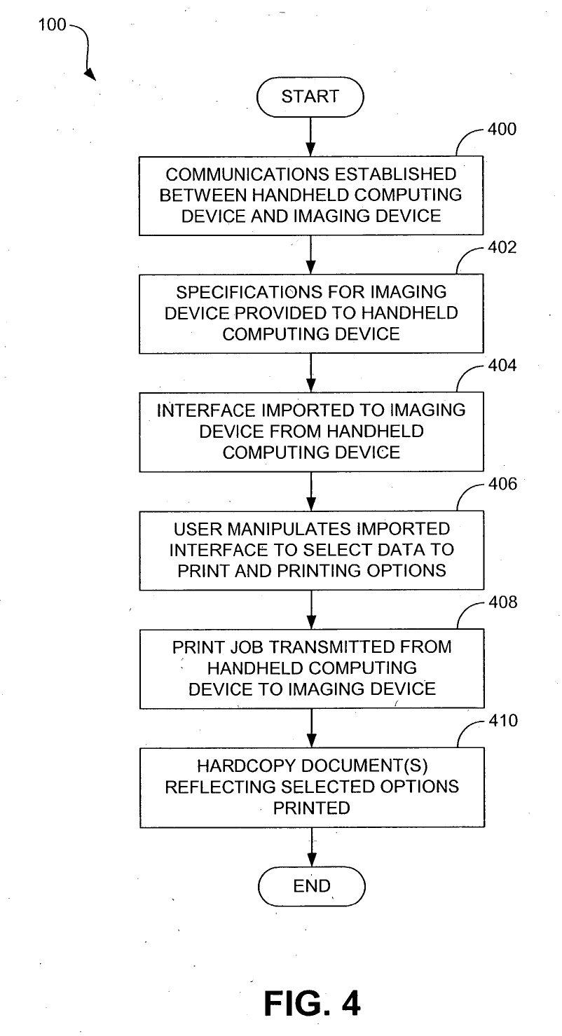

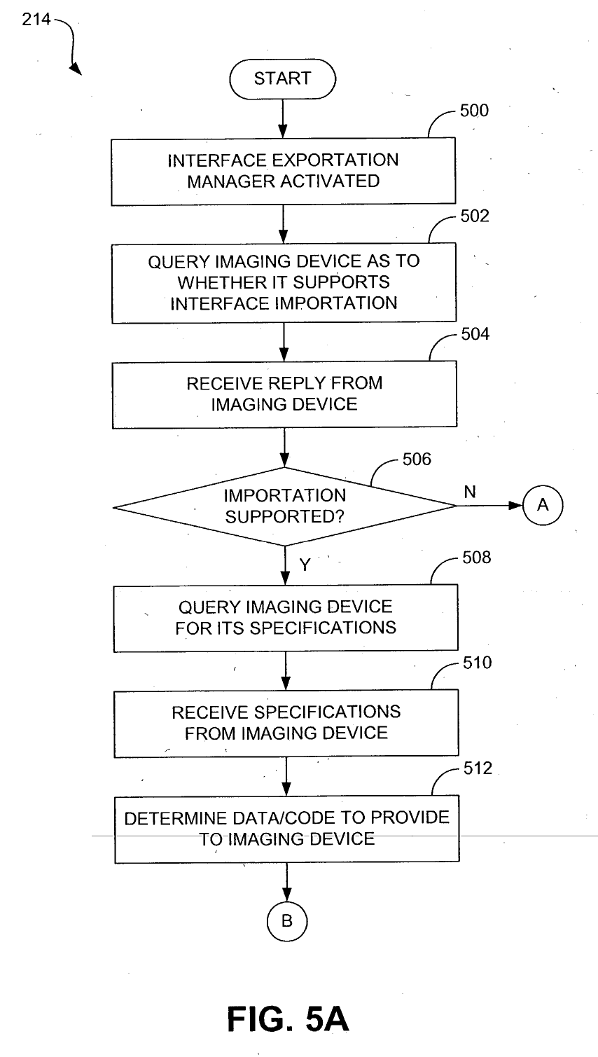

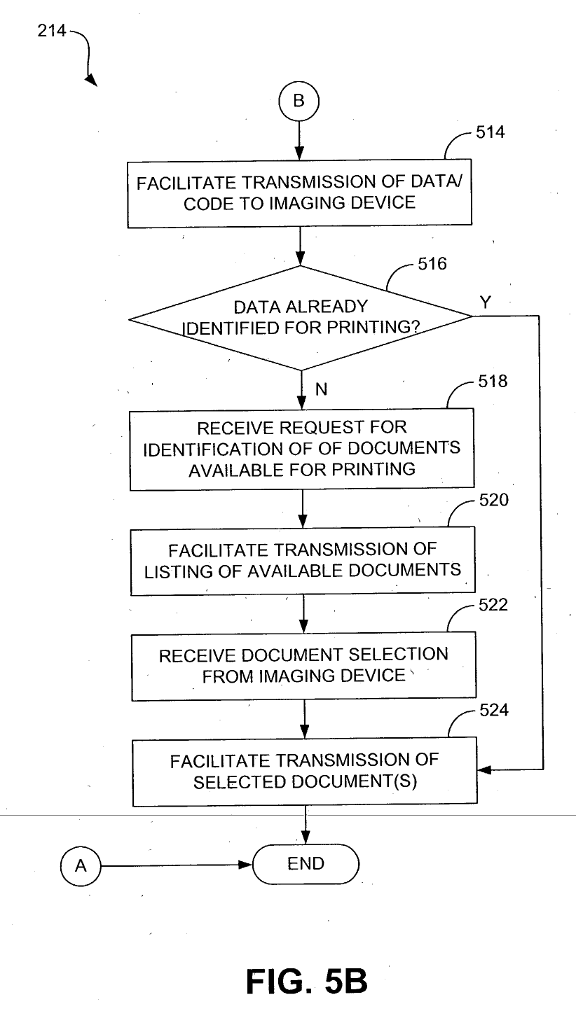

The interface exportation manager 214 is used to export an interface from the handheld computing device 102 to the imaging device 104. As is described in greater detail below, the interface facilitates printing and selection of documents to print and various imaging device options. As indicated in FIG. 2, the interface exportation manager 214 comprises, or has access to, data and/or code 216 that facilitates the generation and support of an exported interface on the imaging device 104. Operation of the interface exportation manager 214 is discussed with respect to FIGS. 4 and 5.

FIG. 3 is a block diagram illustrating an example architecture for the imaging device 104 shown in FIG. 1. As indicated in FIG. 3, the imaging device 104 comprises a processing device 300, memory 302, a print engine 304, user interface devices 306, the display 110 (FIG. 1), and a transceiver 308. Each of these components is connected to a local interface 310 that, by way of example, comprises one or more internal buses. The processing device 300 is adapted to execute commands stored in memory 302 and can comprise a general-purpose processor, a microprocessor, one or more application-specific integrated circuits (ASICs), a plurality of suitably configured digital logic gates, and other electrical configurations comprised of discrete elements both individually and in various combinations to coordinate the overall operation of the imaging device 104. The memory 302 can include any one or a combination of volatile memory elements (e.g., RAM) and nonvolatile memory elements (e.g., ROM, hard drive, etc.).

The print engine 304 comprises the components with which the imaging device 104 generates hardcopy documents. This engine 304 can comprise the common components of a laser-based imaging device, for instance, a paper drive mechanism, charging member, photosensitive member, optical scanning device, developing member, fusing system, etc. Alternatively, however, the engine 304 can comprise the components of an ink-based imaging device, for instance, a paper driver mechanism, an inkjet, etc.

The user interface devices 306 comprise the interface tools with which the device settings can be changed and through which the user can communicate commands to the imaging device 104. By way of example, the user interface devices 306 comprise one or more keys and/or buttons with which the operation of the imaging device 106 can be controlled. The display 110 typically comprises an LCD and, like display 106 of the handheld computing device 102, may be considered a user interface device 306 if touch-sensitive.

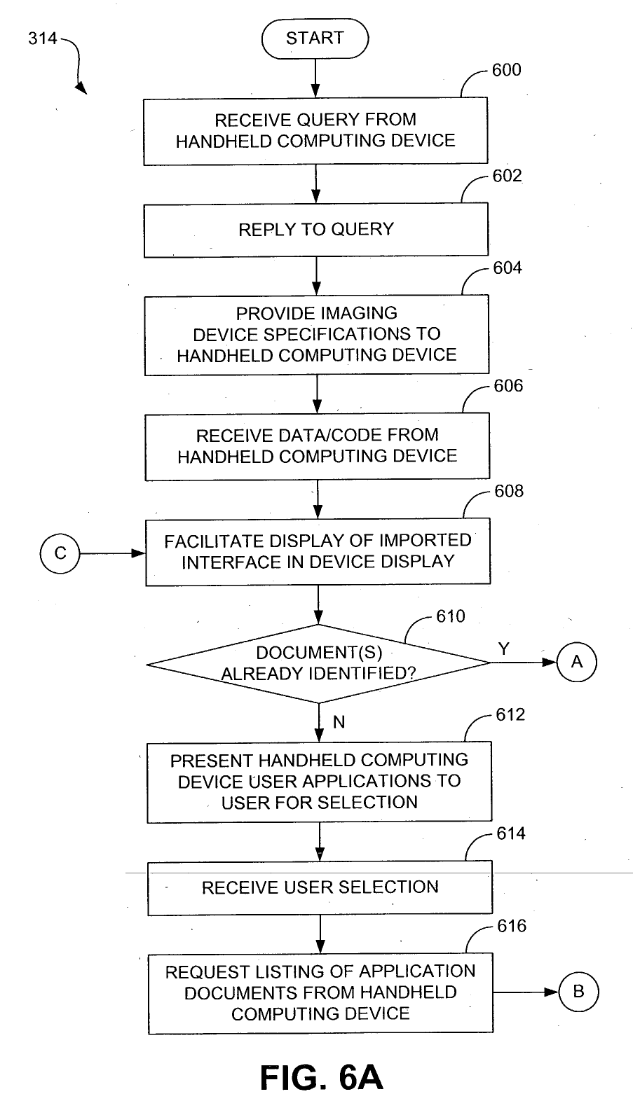

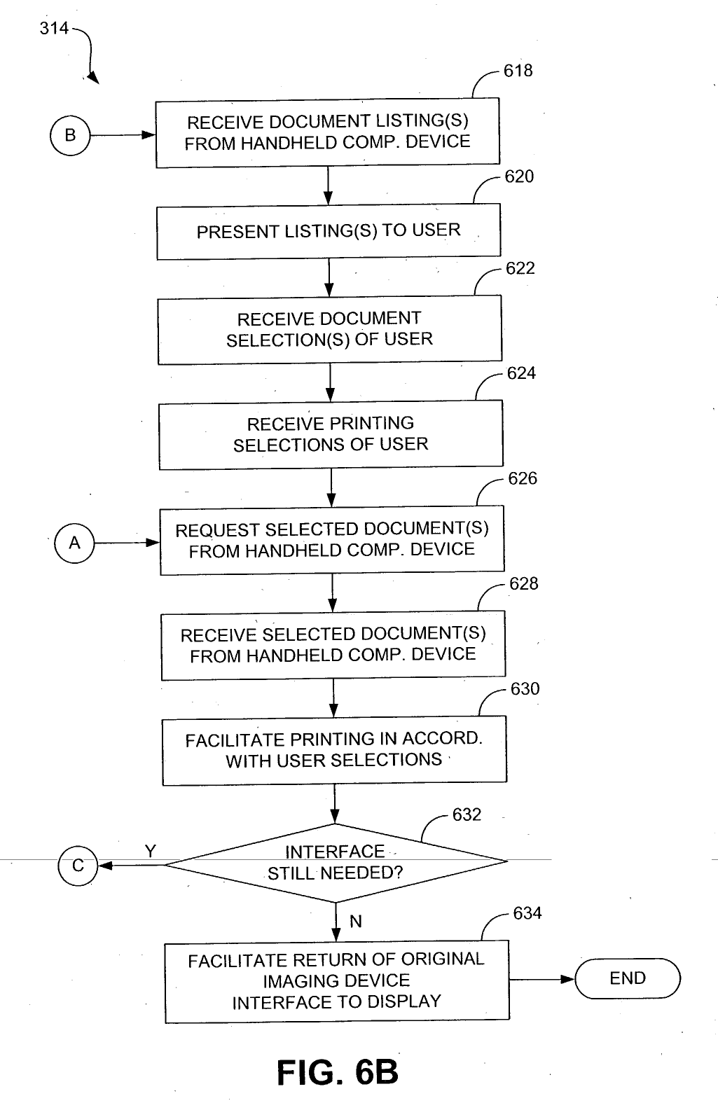

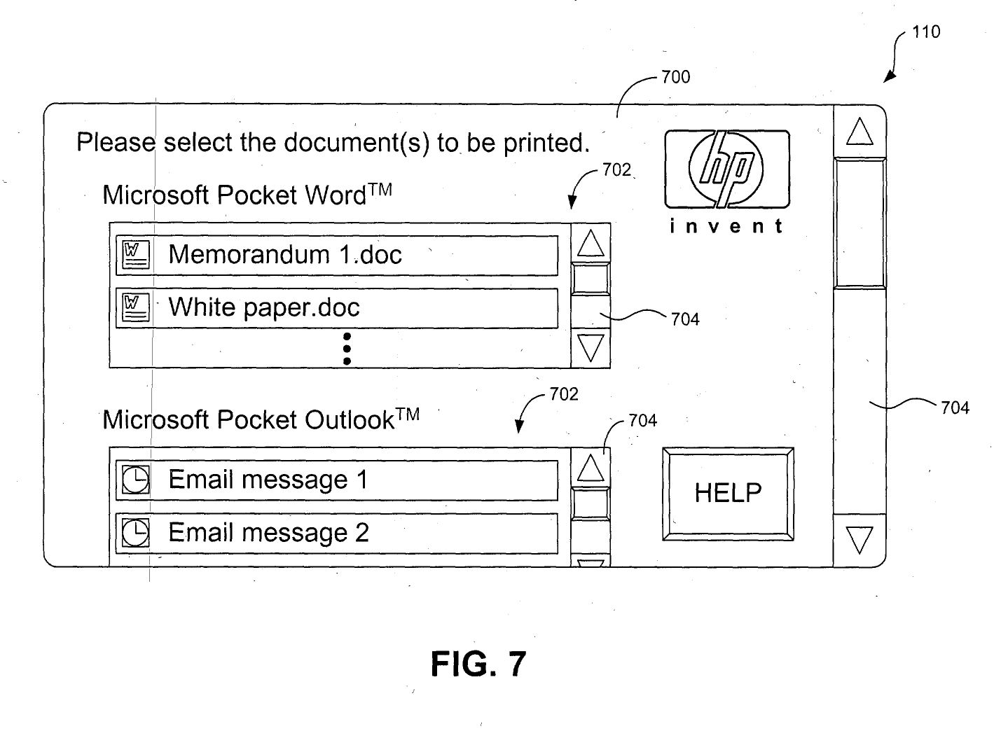

The memory 302 includes various programs (in software and/or firmware) including an O/S 312 that contains the various commands used to control the general operation of the imaging device 104. In addition, the memory 302 includes an interface importation manager 314 that comprises a program that interacts with the interface exportation manager 214 of the user computing device. As is described below, the importation manager 314 is responsible for responding to requests made by the exportation manager 214 and facilitating importation of an interface provided by the exportation manager. As indicated in FIG. 3, the importation manager 314 comprises, or has access to, imaging device specifications 316 that may be provided to the exportation manager 214 to facilitate its exportation of interface data and/or code to the imaging device 104. Operation of the importation manager 314 is discussed with reference to FIGS. 4 and 6.

Various programs have been described above. It is to be understood that these programs can be stored on any computer-readable medium for use by or in connection with any computer-related system or method. In the context of this document, a computer-readable medium is an electronic, magnetic, optical, or other physical device or means that can contain or store a computer program for use by or in connection with a computer-related system or method. The programs can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device.

The computer-readable medium can be, for example, an electronic, magnetic, optical, electromagnetic, infrared, or semiconductor system, apparatus, device, or propagation medium. More specific examples (a nonexhaustive list) of the computer-readable medium include an electrical connection having one or more wires, a portable computer diskette, a random access memory (RAM), a read-only memory (ROM), an erasable programmable read-only memory (EPROM, EEPROM, or Flash memory), an optical fiber, and a portable compact disc read-only memory (CDROM). Note that the computer-readable medium can even be paper or another suitable medium upon which a program is printed, as the program can be electronically captured, via for instance optical scanning of the paper or other medium, then compiled, interpreted or otherwise processed in a suitable manner if necessary, and then stored in a computer memory.

Example systems having been described above, system operation will now be discussed. In the discussions that follow, flow diagrams are provided. Any process steps or blocks in these flow diagrams may represent modules, segments, or portions of code that include one or more executable instructions for implementing specific logical functions or steps in the process. Although particular example process steps are described, alternative implementations are feasible. Moreover, steps may be executed out of order from that shown or discussed, including substantially concurrently or in reverse order, depending on the functionality involved.

As described above, printing from a handheld computing device to a local imaging device can be facilitated by exporting an interface from the handheld computing device to the imaging device. Where the interface has a layout similar to a GUI used to present information to the user on the handheld computing device, the interface exported to the imaging device will have a look and feel that is familiar to the user, thereby facilitating the user's control of the printing process.

An example of such printing is described in FIG. 4. Beginning with block 400, communications are established between the handheld computing device 102 and the imaging device 104. As noted above, these communications typically comprise wireless communications using IR or RF transmission. In the latter case, various different protocols may be used including, for example, wireless application protocol (WAP), ultrawideband (UWB) protocol, 802.11 protocol from the Institute of Electrical and Electronics Engineers (IEEE), or Bluetooth™ protocol from Bluetooth™ SIG™, or another suitable protocol. As described above in relation to FIG. 1, such communications may be facilitated by placing the handheld computing device 102 in a docking station 112 provided on the control panel 108 of the imaging device 104. Although wireless communications are envisioned, direct communication through a physical wire or between mating electrical connectors is feasible where the devices are configured for such coupling.

Through the established communications, various specifications of the imaging device 104 can be provided to the handheld computing device 102, as indicated in block 402. These specifications generally pertain to those capabilities of the imaging device 104 that are relevant to the hosting of an imported interface. By way of example, these specifications relate to the size of the imaging device display 110, whether color images can be presented in the display, whether the imaging device is capable of executing an executable program (e.g., Applet) designed to support the interface, etc. By providing this information to the handheld computing device 102, the computing device need not maintain an up-to-date database of the specifications of each imaging device to which the handheld computing device may print.

Once the specifications have been received, an appropriate interface can be imported to the imaging device 104 from the handheld computing device 102, as indicated in block 404, for presentation in the imaging device display 110. As is discussed in greater detail below, this exportation may involve the transmission of data that represents features to be presented in the display 110, as well as any supporting code that is required to register selection of the features and facilitate transmission of these selections. In some cases, exportation may involve the transmission of one or more executable programs to the imaging device 104 that are configured to generate the interface on the imaging device display 110 and facilitate identification and communication of user selections entered by the user with the interface. In any case, the interface includes selections that pertain to imaging device functionalities, these selections being presented in a layout similar to that typically used in the handheld computing device 102 so that the exported interface has a familiar look and feel to the user, even if the user has never used the imaging device 104. In addition, identified may be data stored on the handheld computing device that are eligible for printing.

Once the interface has been exported from the handheld computing device 102, and imported to the imaging device 104, the user may manipulate features of the interface, for example using an index finger, to select the handheld computing device data to be printed as well as the various printing options that he or she desires, as indicated in block 406. For example, the user may depress onscreen “buttons” to select a document to be printed, the number of copies, whether duplex printing is to be used, whether scaling is to be used, etc. After all desired selections have been made, a print job is transmitted from the handheld computing device 102 to the imaging device 104, as indicated in block 408. At this point, one or more hardcopy documents that reflect the user's selections are printed, as indicated in block 410.

FIGS. 5A and 5B provide an example of operation of the interface exportation manager 214 of the handheld computing device 102. Beginning with block 500 of FIG. 5A, the interface exportation manager 214 is activated. This activation typically occurs automatically upon the establishment of a communication link between the handheld computing device 102 and the imaging device 104. Again, the docking station 112 of the imaging device 104 may facilitate the establishing and maintaining of this link. Once activated, the exportation manager 214 queries the imaging device 104 as to whether it supports interface importation, as indicated in block 502, in particular, the exportation manager 214 queries the imaging device as to whether it can follow a protocol in which the interface normally presented on the imaging device display 110 is replaced with an interface that has a layout similar to that normally provided by the handheld computing device 102 such that the imaging device display is used as a proxy display by the handheld computing device.

After the query has been sent, a reply is received from the imaging device, as indicated in block 504. From this reply, it can be determined, in decision block 506, whether interface importation is or is not supported. If not, exportation of the interface is not feasible and flow for the session is terminated (FIG. 5B). If, on the other hand, interface importation is supported by the imaging device 104, flow continues to block 508 at which the exportation manager 214 queries the imaging device for its specifications. As noted above with reference to FIG. 4, these specifications generally pertain to those capabilities of the imaging device 104 that affect the manner in which the imported interface can be hosted and may specifically pertain to the size of the imaging device display 110, whether color images can be presented in the display, whether the imaging device is capable of executing a received executable program, etc.

After these specifications are received, as indicated in block 510, the interface exportation manager 214 determines what to send to the imaging device 104 to enable it to support the interface. In particular, the exportation manager 214 determines what data and/or code to provide to the imaging device 104 to facilitate its support of the interface, as indicated in block 512. In terms of data, transmitted may be descriptions of the various features (e.g., buttons) to be presented (including text, graphics, and images), their placement within the imaging device display 110, and the colors of the various features (where color is supported by the computing device). In addition, transmitted may be an identification of one or more documents that the user has already identified to be printed (e.g., on the handheld computing device 102 prior to communication between the computing device and the imaging device 104). Alternatively, the exportation manager 214 may facilitate transmission of a listing of source applications that execute on the handheld computing device 102 that may comprise a source of data to be printed by the imaging device 104. For example, these source applications may comprise a word processing application or an email application.

Code that supports these features may include any code necessary to recognize selection of a feature (e.g. button) and register it so that it is communicated back to the handheld computing device 102. This code can be configured to facilitate immediate communicate selections relevant to the handheld computing device 102 for instance the document or documents to be printed, back to the computing device 102. By way of example, this functionality can be provided by an executable program (e.g., Applet) sent to the imaging device 104 that is configured to generate the interface and monitor its use. Although such code may be provided to the imaging device 104, such code may, alternatively, already exist on the imaging device. In such a case, transmission of data alone to the imaging device 104 may be sufficient.

With reference next to block 514 of FIG. 5B, the exportation manager 214 facilitates transmission of the data/code to the imaging device 104. The next step in the process depends upon whether the user had previously identified data (e.g., a document or documents) to be printed (decision block 516). If so, flow continues to block 524 described below. If not, however, the interface exportation manager 214 can, for instance, receive a request for a listing of documents available for printing, as indicated in block 518. By way of example, this request may specify a particular user application 212 of the handheld computing device 102 that contains a document that is to be printed. Once such a request is received, the interface exportation manager 214 facilitates transmission of a listing of documents available for printing to the imaging device 104, as indicated in block 520. By way of example, this listing comprises various documents that are associated with a particular user application 212. After this listing has been transmitted, a response is awaited and, as indicated in block 522, the interface exportation manager 214 receives selection of one or more documents. Once the selection is received, the interface exportation manager 214 may immediately, or upon request by the imaging device 104, facilitate transmission of the selected document(s) to the imaging device 104 for printing.

FIG. 6 illustrates an example of operation of the interface importation manager 314 of the imaging device 104. Beginning with block 600, the importation manager 314 may be activated upon receiving a query from the handheld computing device 102 and, more particularly, from the interface exportation manager 214 of the computing device. As noted above, this query may pertain to whether the imaging device 102 supports interface importation. In addition, the query may pertain to the specifications of the imaging device 104. Once the query or queries are received, the importation manager 314 replies, as indicated in block 602. This reply, or a reply to a separate query, may comprise providing the imaging device specifications to the handheld computing device 102, as indicated in block 604.

Next, data and/or code is received from the handheld computing device 102, as indicated in block 606. As noted above, the data may include any data needed to generate an interface on the imaging device display 110, as well as data indicating a document or documents stored on the handheld computing device 102 that is/are to be printed. In an alternative embodiment, the data can comprise identification of user applications 212 of the handheld computing device 102 from which documents available for printing may originate. At this point, the importation manager 314, at minimum, has the information and/or code it needs to present an interface to the user in the control panel display 110 that has a layout similar to the interfaces normally used on the handheld computing device 102. By way of example, the interface can use the same fonts used with the handheld computing device 102, the same size, shape, and color of features (e.g., buttons) used with the computing device, the same arrangement of these features used with the computing device, etc. It is noted that, although the entire imaging device display 110 may be used to support the interface, a “split screen” arrangement may alternatively used so that a portion of a imaging device interface is still visible.

The next step in the process depends upon whether one or more documents to be printed had been identified to the imaging device 104 in block 606 (decision block 610). If so, the documents to be printed need not be determined, and flow continues to block 626 described below. If no documents had previously been identified, however, and assuming the handheld computing device 102 at least identified the various user applications 212 from which such documents may originate, flow continues to block 612 at which the importation manager 314 presents the various user applications to the user for selection. For example, if the user wishes to print an email message, the importation manager 314 would identify the handheld computing device email application for selection. Once these applications 212 are presented for selection, a user selection can be received, as indicated in block 614. With this selection, the importation manager 214 can then query the handheld computing device 102 for a listing of documents that pertain to that particular application, as indicated in block 616.

After this listing of documents has been received, as indicated in block 618 of FIG. 6B, the listing is presented to the user in the control panel display 110, as indicated in block 620, so that the user can select the document or documents that the user wishes to print. This selection can be facilitated by, for instance, presenting a list of documents that the user may browse. An example of such facilitation is depicted in FIG. 7. Specifically, shown is the imaging device control panel display 110 while displaying an interface screen 700 that comprises one or more listings 702 that pertain to the user applications 212 (FIG. 2) that the user identified to the importation manager 314 as containing a document to be printed. In the example of FIG. 7, these applications comprise Microsoft Pocket Word™ and Microsoft Pocket Outlook™. The user can select documents from the listing(s) 702 by simply pressing on the display 110 over the desired document(s) using an index finger, or by “tabbing” through the listing using actual, physical buttons of the imaging device control panel 108. Where a listing 702 is long, documents not immediately visible may be accessed by scrolling, for instance using scroll bars 704.

Returning to FIG. 6B, once the user selection is received (block 622), the importation manager 314 can then receive the various printing option selections that the user wishes to enter, as indicated in block 624. These selections can be facilitated by another interface screen (not shown) that is presented to the user in the control panel display 110. These selections pertain to the various capabilities of the imaging device 104 and may, therefore, relate to the number of copies to be generated, whether duplex printing is to be used, whether scaling is to be used, various document finishing options, etc. Accordingly, through interface exportation, greater control over the print process is provided to the user.

Once the various printing selections have been made, flow continues to block 626 at which the importation manager 314 requests the selected document(s) be sent from the handheld computing device 102 to the imaging device 104. In particular, the importation manager 314 facilitates transmission of a document request to the handheld computing device 102. These documents can then be transmitted by the handheld computing device 102 to the imaging device 104 and, as indicated in block 628, can be received by the importation manager 314. At this point, the importation manager 314 can facilitate printing of the selected document(s) in accordance with the user's printing selections, as indicated in block 630.

Next, it is determined in decision block 632 whether an imported interface is still needed. In other words, it is determined whether the printing session is terminated. Termination of the printing session can be indicated by the user by, for instance, selecting a “disconnect” button provided in one of the interface screens (not shown) of the control panel display 110, or by simply breaking the communication link that had been established between the handheld computing device 102 and the imaging device 104. In either case, flow continues to block 634 at which the interface importation manager 314 facilitates the return of the original imaging device interface to the device display 110. This may comprise deleting all data and/or code received from the handheld computing device 102. Alternatively, however, the data/code may be stored for later use in memory 302.

What is claimed is:

1. Method for facilitating printing, comprising:
importing an interface transmitted by a computing device;
facilitating display of the imported interface;
receiving selections entered by a user using the imported interface; and
facilitating printing in accordance with the user selections.

2. The method of claim 1, wherein importing an interface comprises importing a graphical user interface (GUI) having a layout similar to GUI of the computing devices.

3. The method of claim 1, wherein importing an interface comprises receiving data pertinent to generating the interface on a display of an imaging device.

4. The method of claim 1, wherein importing an interface comprises receiving from the computing device code used to recognize selection of a feature presented in the interface.

5. The method of claim 4, wherein receiving code comprises receiving an executable program from the computing device.

6. The method of claim 1, wherein importing an interface comprises importing an interface from a handheld computing device.

7. The method of claim 1, further comprising receiving from the computing device identification of a document to be printed when the interface is imported.

8. The method of claim 1, further comprising receiving from the computing device identification of documents stored on the computing device that are eligible for printing and presenting these documents to the user in the imported interface for selection.

9. The method of claim 8, further comprising receiving selection of a document to be printed entered by the user using the imported interface.

10. The method of claim 9, further comprising requesting and receiving the selected document from the computing device.

11. The method of claim 1, further comprising facilitating transmission of specifications regarding the imaging device prior to importing an interface.

12. A method for facilitating printing, comprising:
exporting an interface to an imaging device;
receiving selection of a document to be printed from the imaging device that has been entered by a user using the exported interface; and
facilitating transmission of the selected document to the imaging device to facilitate printing of the document.

13. The method of claim 12, wherein exporting an interface comprises facilitating transmission to the imaging device of data pertinent to generating the interface on an imaging device display.

14. The method of claim 12, wherein exporting an interface comprises facilitating transmission to the imaging device of code used to recognize selection of a feature presented in the interface.

15. The method of claim 14, wherein facilitating transmission of code comprises facilitating transmission of an executable program to the imaging device.

16. The method of claim 12, further comprising facilitating transmission to the imaging device of identification of a document to be printed when the interface is exported to the imaging device.

17. The method of claim 12, further comprising facilitating transmission of a listing of documents eligible for printing to the imaging device for selection by a user using the exported interface.

18. The method of claim 12, further comprising querying the imaging device for imaging device specifications and determining what data or code to be transmitted to the imaging device depending upon the specifications received from the imaging device.

19. An interface importation manager stored on a computer-readable medium, comprising:
logic configured to receive an interface from a computing device;
logic configured to facilitate presentation of the received interface in an imaging device display;
logic configured to recognize selections entered by a user using the received interface; and
logic configured to facilitate printing in accordance with the selections made by the user using the received interface.

20. The manager of claim 19, wherein the logic configured to receive an interface comprises logic configured o receive and implement data pertinent to generating the interface on the imaging device display.

21. The manager of claim 19, wherein the logic configured to receive an interface comprises logic configured to receive and implement code used to recognize selection of a feature presented in the interface.

22. The manager of claim 19, further comprising logic configured to query the computing device for documents eligible for printing, logic configured to receive identification of documents eligible for printing, and logic configured to present the documents to the user for selection using the interface.

23. The manager of claim 22, further comprising logic to receive a document selection entered by the user using the interface, logic configured to request the selected document from the computing device, and logic configured to receive the requested document.

24. The manager of claim 19, further comprising logic configured to facilitate transmission of specifications regarding the imaging device to the computing device.

25. An interface importation manager, comprising:
means for receiving an interface transmitted by a computing device;
means for implementing the received interface;
means for recognizing selections entered by a user using the interface; and
means for facilitating printing in accordance with the recognized user selections.

26. An interface exportation manager stored on a computer-readable medium, comprising:
logic configured to facilitate transmission of an interface to an imaging device so that the interface can be displayed in an imaging device display;
logic configured to receive a request for a document to be printed that has been selected by the user using the interface; and
logic configured to facilitate transmission of the document to the imaging device for printing.

27. The manager of claim 26, wherein the logic configured to facilitate transmission of an interface is configured to facilitate transmission of data pertinent to generating the interface on the imaging device display.

28. The manager of claim 26, herein the logic configured to facilitate transmission of an interface is configured to facilitate transmission of code configured to recognize selection of a feature presented in the interface.

29. The manager of claim 26, further comprising logic configured to receive specifications regarding the imaging device and logic configured to determine what data or code to be transmitted to the imaging device in view of the received specifications.

30. An interface exportation manager, comprising:
means for transmitting an interface to an imaging device;
means for receiving identification of a document to transmit to the imaging device; and
means transmitting the identified document to the imaging device.

31. An imaging device, comprising:
a processing device;
a print engine;
a display; and
memory including an interface importation manager, the manager being configured to receive an interface from a handheld computing device, to facilitate presentation of the received interface in the display, and to facilitate printing in accordance with selections made by the user using the presented interface.

32. A handheld computing device, comprising:
a processing device; and
memory including an interface importation manager, the manager being configured to facilitate transmission of an interface to an imaging device, to receive a request for a document to be printed that has been selected by the user using the interface, and to facilitate transmission of the selected document to the imaging device for printing.
